(19) United States
(12) Patent Application Publication
(10) Pub. No.: US 2013/0046602 A1
(43) Pub. Date: Feb. 21, 2013

(54) METHOD OF PROVIDING AN OFFER BASED ON PROXIMITY TO A POINT OF SALE TRANSACTION

(71) Applicants: David M. Grigg, Rock Hill, SC (US); Matthew A. Calman, Charlotte, NC (US); Raja Bose, Charlotte, NC (US); Erik Stephen Ross, Charlotte, NC (US)

(72) Inventors: David M. Grigg, Rock Hill, SC (US); Matthew A. Calman, Charlotte, NC (US); Raja Bose, Charlotte, NC (US); Erik Stephen Ross, Charlotte, NC (US)

(73) Assignee: BANK OF AMERICA CORPORATION, Charlotte, NC (US)

(21) Appl. No.: 13/212,009

(22) Filed: Aug. 17, 2011

(51) Int. Cl. G06Q 30/00

(52) U.S. Cl. 705/14.25; 705/14.38

(57) ABSTRACT

Embodiments of the invention include systems, methods, and computer-program products that provide for a unique offer system, wherein the offer is generated based on proximity to a point-of-transaction device. In one embodiment of the invention, the computer-implemented method receives data associated with a financial transaction at a point-of-transaction device. The computer-implemented method then identifies the identity of the user conducting the transaction and the location of the transaction. Using the location of transaction, the computer-implemented method determines offers located in proximity to the user and provides those offers to the user. In some embodiments, the offers are customized for the user based on some characteristic of the transaction or the user. In further embodiments, the user is guided to a business associated with the offer by directions provided by the computer-implemented method.

### BACKGROUND

Currently, businesses offer products and services to customers based on the customer's known place of residence or to customers who reside within the geographic area of the business. These offers, however, are not directed to customers that are already shopping. Further, these offers are not specific to the customer's location. For this reason, the offers provided by the businesses are often not effective in modifying the customer's behavior. Businesses therefore waste money and time providing offers to customers that do not want to shop and may not be near where the business is located.

Likewise, customers are creatures of habit and many customers prefer to combine trips to businesses to efficiently conduct their transactions. Customers may receive offers for businesses in a larger geographic region, such as a town or city, but these offers may not be directed to a product or process that the user is currently looking for. Customers are also busy and prefer convenient shopping experiences where their desires are anticipated compared to taking the inconvenient and risky chance that a business they visit is having a sale. Customers do not have time to search through all the available sales and offers to determine which of the businesses near their current location has a current offer.

Financial institutions look to serve both business clients and customers. For example, financial institutions look to provide tailored marketing strategies so that businesses are effectively using marketing resources and customers are receiving useful information in a convenient manner.

Therefore, a need exists for a computer-implemented method and system that can identify when a customer is conducting a transaction and provide offers to the user based on the current location of the user in order to target offers for goods and services that may be relevant to the customer.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Some embodiments of the present invention provide a computer-implemented method for providing offers based on proximity to a point-of-transaction (“POT”) that involves receiving data associated with a transaction at a point-of-transaction device, identifying a user associated with the data, determining a location of the point-of-transaction device, and providing an offer to the user based at least in part on the location of the point-of-transaction device. In some embodiments, the proximity determination will be made based on a straight-line distance. In other embodiments, the proximity determination is made based on network analysis or travel time analysis. For example, the computer-implemented method may determine how long it would take the user to reach each one of the available offers and select the offer that would take the shortest amount of time to reach. Certain embodiments will feature the additional steps of determining an offer to provide the user from a plurality of offers. The computer-implemented method may determine the offer based on the user's financial transaction history.

Embodiments of the present invention provide a system for providing an offer based on proximity to a point-of-transaction transaction. In an embodiment of the invention, the system includes a computing platform including a processor and a memory. The system also includes an identification routine stored in the memory and executable by the processor. The identification routine is configured to identify the user from data received from the point-of-transaction device and to identify the location of the point-of-transaction device. The system further includes a proximity database stored in the memory and configured to provide data associated with the location of the point-of-transaction device. The system further includes an offer selection routine stored in the memory and executable by the processor. The offer selection routine is configured to determine an offer to provide to the user based on proximity to the point-of-transaction device. Further, the system includes an offer routine stored in the memory and executable by the processor. The offer routine is configured to provide the offer to the user.

Embodiments of the present invention further provide a computer program product comprising a non-transitory computer readable medium having computer executable program code embodied therein for providing an offer based on proximity to a point-of-transaction transaction. In one embodiment, the computer-readable medium includes: a first set of codes for causing a computer to receive data associated with a transaction at a point-of-transaction device, the data comprising financial account information; a second set of codes for causing the computer to identify a user conducting the transaction from the financial account information; a third set of codes for causing the computer to determine a location of the point-of-transaction device; a fourth set of codes for causing the computer to determine an offer in proximity to the point-of-transaction device; and a fifth set of codes for causing the computer to provide the offer to the user.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, wherein:

FIG. 1 is a flow chart of a method for providing an offer based on proximity to a point-of-transaction device, in accordance with some embodiments of the invention;

FIG. 2 is a depiction of an environment in which an offer based on proximity to a point-of-transaction device is provided to a user, in accordance with some embodiments of the invention;

FIG. 3 is a block diagram of a proximity database, in accordance with some embodiments of the invention;

FIG. 4 is a block diagram of a financial institution's banking system, in accordance with some embodiments of the invention;

FIGS. 5a and 5b are flow charts of a computer-implemented method for providing offers based on proximity to a point-of-transaction device, in accordance with some embodiments of the invention;

FIG. 6 is a schematic of a map showing proximity determinations for offers in proximity to a user conducting a transaction, in accordance with some embodiments of the invention;

FIG. 7 is an example of a mobile device receiving an offer, in accordance with some embodiments of the invention; and

FIG. 8 is a schematic of a map showing path-dependent proximity determinations for point-of-transaction devices near a user conducting a transaction, in accordance with some embodiments of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

People are busy and often like to combine trips to stores to save time when shopping. Additionally, businesses and organizations like to provide offers to individuals that are close to them. The businesses know that individuals may visit their store if the individuals are aware of the business's proximity. Also, individuals that are contacted when in a shopping mode may be more likely to visit nearby stores to complete their shopping needs. A computer-implemented method that alerts users to nearby businesses in which the user may be interested when the user is already conducting a transaction will allow users to increase efficiency when shopping and provide convenience to both users and businesses when marketing products and services.

The embodiments described herein may refer to use of a transaction or transaction event to trigger the location of the user and/or the user's mobile device. In various embodiments, occurrence of a transaction also triggers the sending of information such as offers and the like. Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

The disclosure further discusses determination of a user's location. As discussed, user location can be determined by interaction of the user with a point-of-transaction device as discussed above. Location of the user could also be determined based on output from accelerometers, gyroscopes, earth magnetic field sensors, air-pressure sensors (altitude), etc.

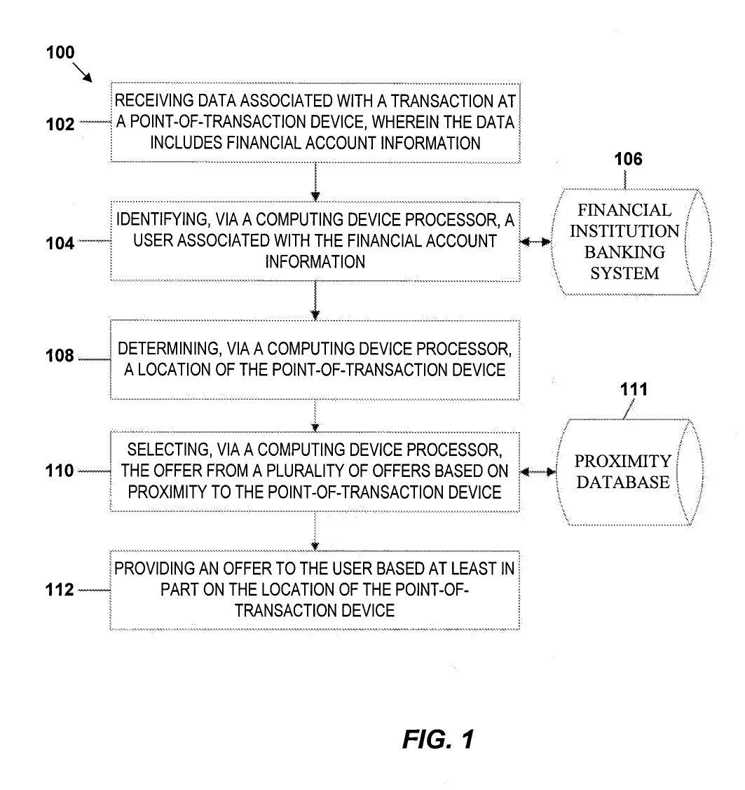

As illustrated in FIGS. 1-8, aspects of the present disclosure include methods, systems, and computer program products directed to a computer-implemented method and system of providing offers to users, wherein the offers are triggered by point-of-transaction transactions. In an exemplary embodiment, the offers are based on proximity to the user when the user is conducting the transaction at the point-of-transaction device. In further embodiments, the user's transaction history is evaluated to customize the offers for the user. In a still further embodiment, computer-implemented method and system provides directions to the user to assist the user in locating a business associated with the offer. For example, the computer-implemented method and system may provide turn by turn directions to the user such that the user is able to locate the business quickly and easily. It will be appreciated that, although embodiments of the present invention are generally described herein in the context of advertisements for-profit businesses, other embodiments of the invention may be adapted to provide other types of offers for other types of organizations.

In one embodiment of the invention, a computer-implemented method of providing offers based on proximity to a point-of-transaction transaction is provided. The computer-implemented method provides a service to bank customers by offering useful, and in some cases customized, offers to appropriate users. For example, a financial institution may receive data associated with a financial transaction at the point-of-transaction device, identify the user associated with the transaction, determine the location of the point-of-transaction device, select the offer from among a plurality of offers, and provide the offer to the user. In some embodiments, the offer is customized for the user based on the user's previous transactions, the location, or other information available at the point-of-transaction device, from the user, or from the financial institution. In a still further embodiment, the computer-implemented method provides directions to the business associated with the offer to further enhance service for the user. The user may opt-in to the program, such to receive offers from the system. Determination of offers and customization procedures using the computer-implemented method are discussed in more depth below with regard to FIGS. 1-8. The transactions at the point-of-transaction device will generally be discussed with regard to purchases though it should be understood that other types of transactions are possible. For example, returns, credit checks, balance inquiries (e.g., at an ATM, etc.), and transfers may all trigger an offer based on proximity to the point-of-transaction device.

FIG. 1 illustrates a general process flow 100 of a computer-implemented method for providing offers based on proximity to a point-of-transaction transaction in accordance with an embodiment of the invention. In block 102, the computer-implemented method receives data associated with a transaction at a point-of-transaction device, wherein the data includes financial account information. In an embodiment, the computer-implemented method receives the data over a network, such as a transaction processing network or wireless network. The data may be encrypted for security. In some embodiments, the data include financial account information or a proxy for financial account information. For example, the data may include the name and/or financial account number of a first party, e.g., a payor, to the transaction and an account number and/or financial account number of a second party, e.g., a payee. The data may further include the amount of the transaction, the time and date of the transaction, the location of the transaction, a category of the transaction, or other information.

The point-of-transaction device is a device that facilitates the transaction between the user and the business or organization. In an embodiment, the point-of-transaction device is a cash register at a store. In other example, the point-of-transaction device is mobile, such as a mobile ice cream truck. In other embodiments, however, the point-of-transaction device is associated with commerce but does not process a transaction. For example, the user may be having a credit check run. Automated teller machines (ATMs) are also considered point-of-transaction devices that may trigger offers to proximately located businesses or organizations. The user can initiate the transaction at a variety of point-of-transaction devices, thereby triggering proximately-located offers.

In block 104, the computer-implemented method identifies, using a computing device processor, a user associated with the financial account information and if the user associated with the financial account information has opted-in to the program to receive offers. In some embodiments, the computer-implemented identifies the user by identifying an account number associated with the transaction and then matches the account number with the user. In another embodiment, the user is identified from the data received from the transaction. In some embodiments, the user conducts a transaction using a mobile device, such as a mobile payment application on a phone. In other embodiments, however, the user is identified by the user's use of a credit card, debit card, rewards card, or personal check. In some embodiments, the computer-implemented method identifies the user in conjunction with a financial institution database 106. In other embodiments, the computer-implemented method identifies the user from secondary sources such as social networking sites.

In block 108, the computer-implemented method 100 determines the location of the point-of-transaction device. In an embodiment, the computer-implemented method determines the location of the point-of-transaction device without using a GPS device. For example, the location of the point-of-transaction device may be determined based on the location of the user. The user's location may be determined based on the user's mobile device, such as triangulating or proximity to cell phone towers, social network data, or internet search data. In some embodiments, the location of the point of sale device is provided in the data received regarding the transaction. For example, the transaction data may include the street address, the geographic coordinates from an onboard GPS unit associated with a mobile device, or an accelerometer associated with the mobile device. In another embodiment, the computer-implemented method determines the location in conjunction with the financial institution database 106 or online databases, such as online mapping databases. In some embodiments, the location is determined to a high degree of precision, such as that provided by a GPS unit. In other embodiments, however, the location is provided at a more general level of detail. For example, a locale of the point-of-transaction device may be provided, wherein the locale is a mall, a shopping center, or other region defined by common characteristics. The location of the point-of-transaction device may be determined at varying levels of detail and still used to provide offers located in the proximity of the point-of-transaction device. For example, all businesses in a shopping mall may be considered as in the same locale and therefore offers from those businesses would be in the proximity of a user conducting a transaction at any of the businesses.

Turning now to block 110, the computer-implemented method 100 determines an offer for the user from a plurality of offers. In some embodiments, the offers may be received by the user only after the user has opted-in to receive the offers. In an exemplary embodiment of the invention, the offer is selected based on proximity to the point-of-transaction device where the user is currently conducting a transaction. In this way the system may recognize the location of the user, the business associated with the location of the user, and predict where the user is likely to go next. The computer-implemented method 100 assists the user in locating nearby business and opportunities that the user may be interested in and that may be easily or quickly accessed by the user. Proximity determinations may be made using geometry, map logic, accelerometer, or other means to determine the distance between the user's current location and the location of the offer. In an embodiment, the distance between the user's current location and the offer is straight-line distance. In other embodiments, the distance between the user's current location and the offer is determined based on the user driving, the user walking, the user biking or other modes of transporting (e.g., bus, train, etc.). In one embodiment, the proximity is based on travel time rather than distance. For example, a first offer that is a farther geographic distance from the user than a second offer but where the first offer would take less travel time to reach may be determined as in proximity to the offer and selected for display.

In one embodiment of the invention, the offer is an advertisement. In an embodiment, the offer is an advertisement for a business or service. For example, the offer may be an offer to visit a business that is near the location where the user is currently shopping. In other embodiments, the offer may include a coupon, a solicitation, a request for volunteer service, or an offer to visit a tourist site, etc. The coupon may be customized for the user to be both close to the user's current location as well as targeted to a business that the user has already purchased from. The offer can be customized in a variety of ways, as will be discussed in greater detail later.

In block 112, once the computer-implemented method 100 determines the offer to provide to the user, the computer-implemented method 100 provides the offer to the user. In some embodiments, the computer-implemented method determines contact information for the user and contacts the user using the contact information. For example, the user may have provided a phone number, an email address, a social networking ID, or other contact means. The computer-implemented method 100 may send the user a text or SMS message, in some embodiments an automatically-generated text message, providing the user details of the offer. In another example, the computer-implemented method provides the offer to the user via an email, such as an email with web-enabled hyperlinks embedded therein, so that the user can gather more information regarding the offer. In still further examples, the offer may be provided to the user via a phone call, such as an automatically generated, a pre-recorded, or a live phone call from a representative of the organization associated with the offer. The offers could be sent to via user's TV, in-car video/audio, or the like. For example, offers and navigational directions could be sent to the navigation system on a car.

As will be discussed, the computer-implemented method may have a variety of supplemental steps and accomplish the steps in a variety of ways. Further, the steps do not need to be performed in the order discussed herein. For example, the computer-implemented method may identify the location of the point-of-transaction device prior to the computer-implemented method identifying the user. The examples disclosed herein are not intended to be limiting to the various ways in which the user or location may be identified, or the ways the offer may be provided to the user.

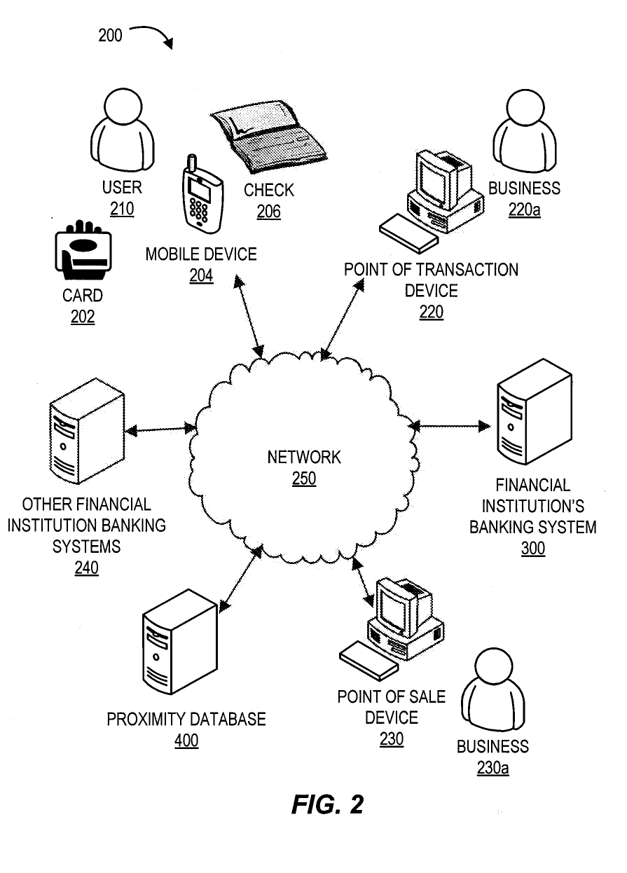

Referring to FIG. 2, a block diagram illustrating an environment 200 in which a user 210 is provided an offer based on proximity to a point-of-transaction device 220 is provided in accordance with an embodiment of the invention. First, in some embodiments, the system may receive an opt-in request from the user 210 to receive offers from the program. As denoted earlier, the user 210 may conduct the transaction using a variety of methods of payment. For example, the user may pay with a card 202, such as a credit card, debit card, or rewards card. In some embodiments, the user pays with a mobile device 204 or a personal check 206. In an embodiment, the personal check 206 is scanned immediately and entered into the banking system so that the computer-implemented method is alerted to the transaction occurring soon after the user conducts the transaction.

When the user 210 conducts the transaction, the point-of-transaction device 220 or the user's mobile device 204 transmits data to the financial institution's banking system 400. In an embodiment, the point-of-transaction device 220 or the user's mobile device 204 transmits the data over a network 250. For example, the data may be transmitted over wired networks, wireless networks, the Internet, Near Field Communication (NFC) networks, Bluetooth™ networks, or the like.

The data transmit over the network 250 to the financial institution banking system 400, where the identity of the user 210, the location of the point-of-transaction device 220, and the offer are determined. In some embodiments, the user 210 is identified in coordination with other financial institution banking systems 240, with the user 210 or the user's mobile device 204, or with the point-of-transaction device 220. In an embodiment, the location of the point-of-transaction device and/or the proximity of the user to other offers are determined using a proximity database 300. The proximity database may be integral with the financial institution's banking system 400 or may be operated separately from the financial institution's banking system 400.

In some embodiments, the financial institution's banking system 400 coordinates with other businesses 230a having point-of-transaction devices 230. For example, the financial institution banking system 400 may communicate with point-of-transaction devices 230 at nearby businesses 230a to determine which of a variety of nearby businesses 230a would be most attractive to the user. For example, the user may be offered advertisements to a restaurant and the financial institution banking system 400 may communicate with nearby restaurants to determine which have the shortest wait time for a table. The other businesses 230a may also provide special offers such as coupons to users at different times and these can be passed on to the user via the financial institution banking system 400.

In the environment 200, the user receives the offer over the network 250 via the user's mobile device 204 or via the point-of-transaction device 220. The user 210 does not need to conduct the transaction using the mobile device 204 in order to receive the offer via the mobile device 204. For example, the user 210 may pay with a credit card and then immediately receive a text message on the user's phone indicating an offer for a nearby business. In other examples, the user 210 receives the offer via an email, via a phone call, or via a social networking contact. The user 210 may also receive the offer as a printed offer on the receipt generated at the point-of-transaction device 220 or may be provided the offer by the business 220a, such as by a person working the cash register who is prompted to provide the offer by the computer-implemented method.

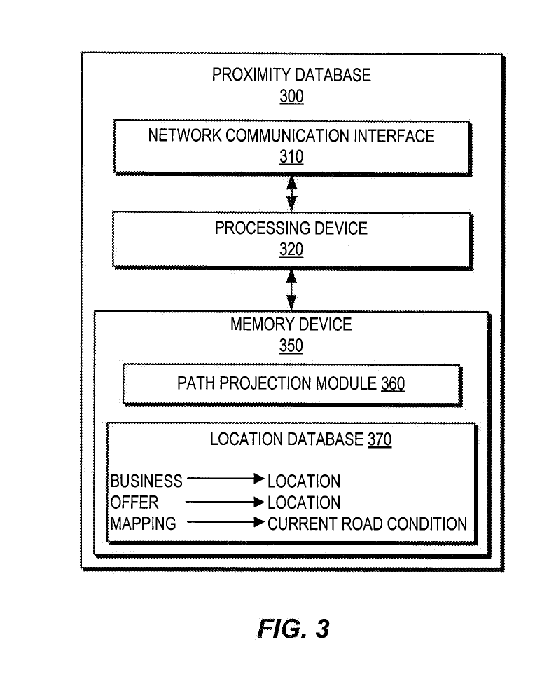

FIG. 3 provides a block diagram illustrating a proximity database 300, in accordance with an embodiment of the invention. In one embodiment of the invention, the proximity database 300 is operated by a second entity that is a different or separate entity from the first entity (e.g., the financial institution) that, in one embodiment of the invention, implements the banking system 400. In one embodiment, the proximity database 300 could be part of the banking system 400. As illustrated in FIG. 3, the proximity database 300 generally includes, but is not limited to, a network communication interface 310, a processing device 320, and a memory device 350. The processing device 320 is operatively coupled to the network communication interface 310 and the memory device 350. In one embodiment of the proximity database 300, the memory device 350 stores, but is not limited to, a proximity determination module 360 and a location database 370. The location database 370 stores data including, but not limited to, the location of organizations such as businesses, the location of ATMs, the locations associated with offers, etc. In one embodiment of the invention, both the proximity determination module 360 and the location database 370 may associate with applications having computer-executable program code that instructs the processing device 320 to operate the network communication interface 310 to perform certain communication functions involving the location database 370 described herein. In one embodiment, the computer-executable program code of an application associated with the location database 370 may also instruct the processing device 320 to perform certain logic, data processing, and data storing functions of the application associated with the location database 370 described herein.

The network communication interface 310 is a communication interface having one or more communication devices configured to communicate with one or more other devices on the network 250. The processing device 320 is configured to use the network communication interface 310 to receive information from and/or provide information and commands to a mobile device 204, other financial institution banking systems 240, the proximity database 300, the banking system 400, and/or other devices via the network 250. In some embodiments, the processing device 320 also uses the network communication interface 310 to access other devices on the network 250, such as one or more web servers of one or more third-party data providers. In some embodiments, one or more of the devices described herein may be operated by a second entity so that the third-party controls the various functions involving the proximity database 300. For example, in one embodiment of the invention, although the banking system 400 is operated by a first entity (e.g., a financial institution), a second entity operates the proximity database 300 that stores the location information and determines the proximity between the user's current location and the offers.

As described above, the processing device 320 is configured to use the network communication interface 310 to gather data from the various data sources. The processing device 320 stores the data that it receives in the memory device 350. In this regard, in one embodiment of the invention, the memory device 350 includes datastores that include, for example: (1) location information for businesses, (2) location information for organizations associated with offers; (3) information regarding means for transportation, such as maps, train schedules, or traffic patterns; and/or (4) historic travel information for users. In an embodiment, the datastores may be added to independently of the banking system 400. For example, businesses wanting to attract customers may provide offers and the locations associated with the offers to a third-party manager, which then updates the memory device 350.

In some embodiments of the invention, the proximity database 300 is configured to be controlled and managed by one or more third-party data providers (not shown in FIG. 2) over the network 250. In other embodiments, the proximity database 300 is configured to be controlled and managed over the network 250 by the same entity that maintains the financial institution's banking system. In other embodiments, the proximity database 300 is configured to be controlled and managed over the network 250 by the financial institution conducting the transaction. For example, the transaction may be conducted through credit card networks rather than brick and mortar bank networks. In still other embodiments, the proximity database 300 is a part of the banking system 400.

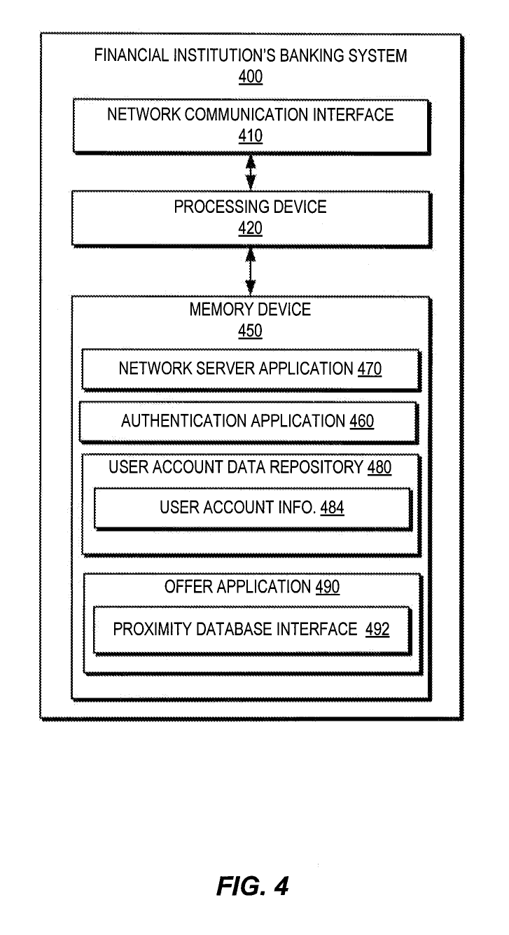

FIG. 4 provides a block diagram illustrating the banking system 400 in greater detail, in accordance with embodiments of the invention. As illustrated in FIG. 4, in one embodiment of the invention, the banking system 400 includes a processing device 420 operatively coupled to a network communication interface 410 and a memory device 450. In certain embodiments, the banking system 400 is operated by a first entity, such as a financial institution, while in other embodiments the banking system 400 is operated by an entity other than a financial institution.

It should be understood that the memory device 450 may include one or more databases or other data structures/repositories. The memory device 450 also includes computer-executable program code that instructs the processing device 420 to operate the network communication interface 410 to perform certain communication functions of the banking system 400 described herein. For example, in one embodiment of the banking system 400, the memory device 450 includes, but is not limited to, a network server application 470, an authentication application 460, a user account data repository 480, which includes user account information 484, an offer application 490, which includes a proximity database interface 492 configured to communicate with the proximity database 300, and other computer-executable instructions or other data. The computer-executable program code of the network server application 470, the authentication application 460, or the offer application 490 may instruct the processing device 420 to perform certain logic, data-processing, and data-storing functions of the banking system 400 described herein, as well as communication functions of the banking system 400.

As used herein, a “communication interface” generally includes a modem, server, transceiver, and/or other device for communicating with other devices on a network, and/or a user interface for communicating with one or more users. Referring again to FIG. 2, the network communication interface 410 is a communication interface having one or more communication devices configured to communicate with one or more other devices on the network 250, such as the mobile device 204, the banking system 400, the other financial institution banking systems 240, and the proximity database 300. The processing device 420 is configured to use the network communication interface 410 to transmit and/or receive data and/or commands to and/or from the other devices connected to the network 250.

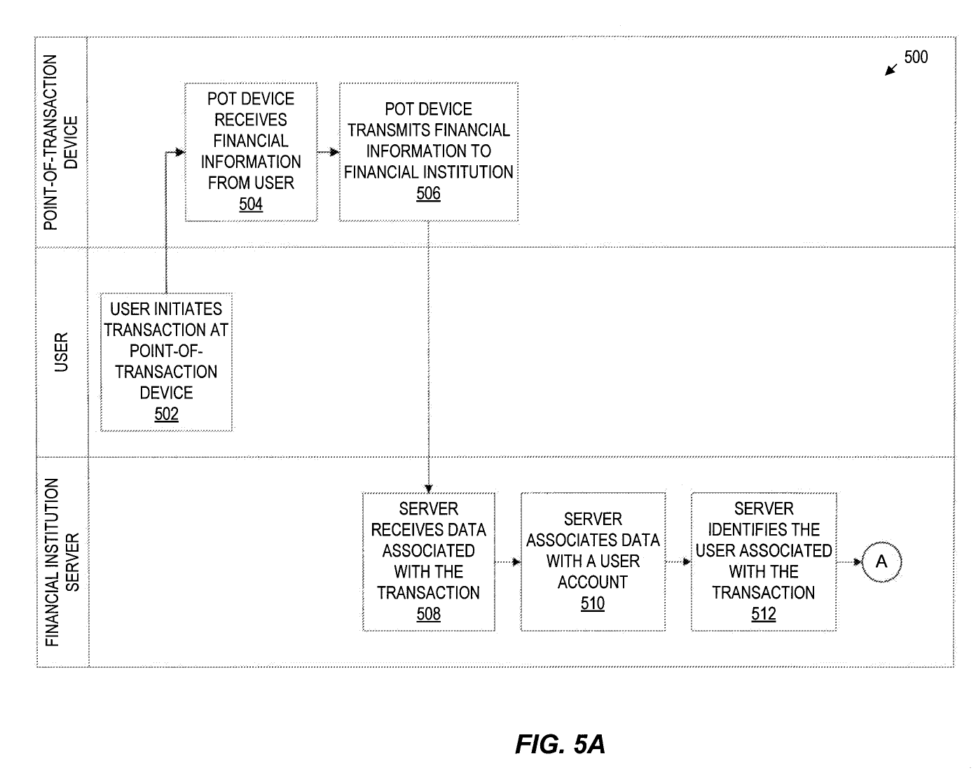

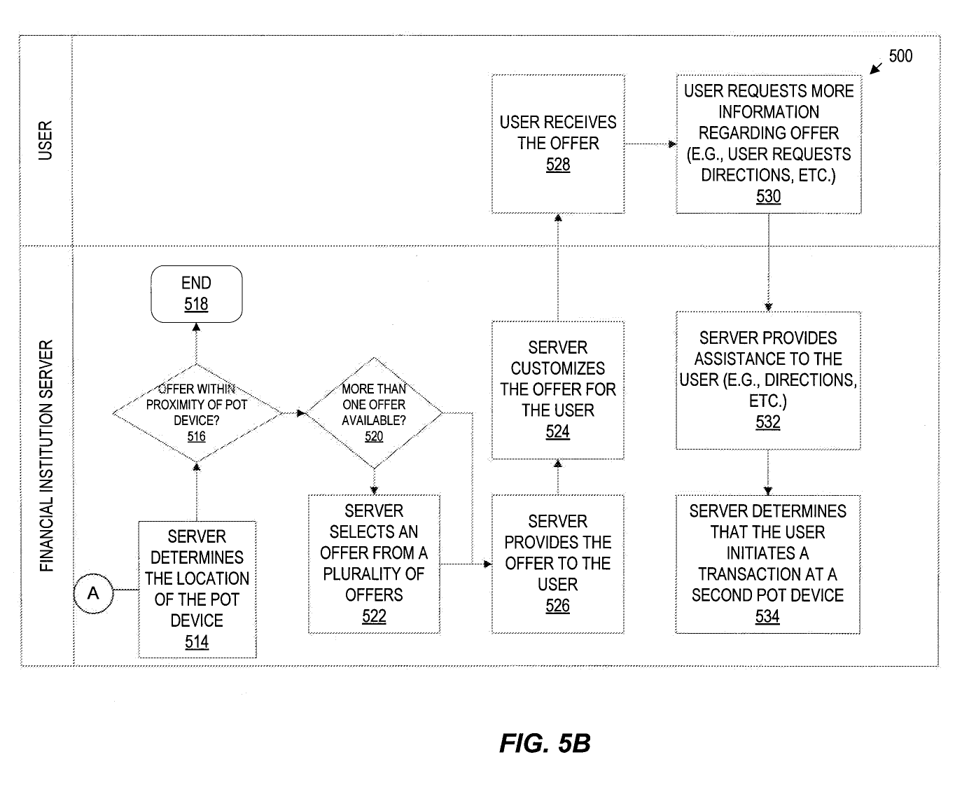

FIGS. 5A and 5B provide a modified flow chart showing actions taken by the user, the point-of-transaction device, and the financial institution server to provide an offer based on proximity to the point-of-transaction device, in accordance with an embodiment of the invention. While the steps are depicted as performed by one of the parties listed in the flow chart, the steps do not need to be performed by that exact party. For example, the point-of-transaction device is depicted as providing the data to the financial institution server in block 504; however, the user may do this instead of or in addition to the point-of-transaction device. The user may provide the data via the user's mobile device.

Prior to the steps of FIGS. 5A and 5B taking place, the user 210, in some embodiments, may determine to opt-in to the program to receive offers. In block 502, the user initiates a transaction at a point-of-transaction device. In an embodiment, the user purchases something at a business by using a credit card, using a mobile payment application on a mobile phone, or pays with a personal check. In other embodiments, the user returns a purchase and provides a card to receive a refund, conducts an action at an ATM, or provides the user's identity to a business. For example, the user may provide identification to a car dealership, which then runs a credit check to determine whether the user is a likely candidate for receiving a car loan. The computer-implemented method determines that the user is having a credit check conducted, identifies the location of the car dealership, and provides an offer to the user from nearby banks that offer car loans.

In block 504, the point-of-transaction device receives financial information from the user. The point-of-transaction device may receive the user's account information including all information used to complete the transaction. In an embodiment, the user swipes a card, such as a debit card, through a credit card reader to provide the information to the point-of-transaction device. In other embodiments, the user activates a mobile payment application on a mobile device, writes a personal check, or inserts a card into an ATM reader. The point-of-transaction device may receive the financial information in an encrypted format or over a secure network. In an embodiment, the point-of-transaction device requests authentication of the user's identity when receiving the financial information.

In block 506, the point-of-transaction device transmits data to the financial institution server. In an embodiment, the data comprises financial institution account data for the user, for the payee, or for both. The financial institution account data may include the user's account number, the payee's account number, or proxies for both. As discussed, instead of or in addition to the point-of-transaction device, the user may transmit data to the financial institution server, such as via a mobile computing application on a mobile device. The point-of-transaction device or user transmits the data over the network. In an embodiment, the network and/or the data are encrypted. The data may include information in addition to the financial institution account data, such as the amount of the transaction, the location of the transaction, and/or the time and date of the transaction.

Turning to block 508, the server receives the data from the point-of-transaction device, including the financial account data. In one embodiment, the server receives the data over the network 250. In some embodiments, the server decrypts the data into a format that the server is able to review. In an embodiment, the server receives the data from the point-of-transaction device and supplements the data with information from secondary sources. For example, the data may be supplemented with the time of the transaction, with the method that the transaction is being conducted (e.g., credit card, mobile payment device, etc.), or with the category that the business where the transaction is occurring is within (e.g., a grocery store, a restaurant, a clothing store, etc.).

In block 510, in order to identify the user, the server associates the financial account data with a user account. In an embodiment, the server interacts with a financial institution database to look up the account number and identify the user name associated with the account number.

In block 512, the server identifies the user from the user account. In an embodiment, the server also identifies contact information for the user. For example, the server may identify a phone number, email address, social networking ID, or other means to contact an individual. In one embodiment, the contact information is provided by the user. In another embodiment, however, the server identifies the contact information from secondary information, such as credit reports, the Internet, or other publicly available information.

Turning to block 514, the server determines the location of the point-of-transaction device. In an embodiment, the location of the point-of-transaction device is provided in the data received from the point-of-transaction device. In some embodiments, however, only the name or an account number of the business associated with the point-of-transaction device is provided. In these embodiments, the server determines the location of the point-of-transaction device in another manner. In some embodiments, the server determines the location of the point-of-transaction device in conjunction with the proximity database 300. For example, the proximity database may include records relating to businesses and locations. In another embodiment, the location of the point-of-transaction device is determined based on the records associated with the business available to the financial institution. For example, the mailing address for account statements may be used as the location for the point-of-transaction device associated with a business. In another embodiment, the server accesses data sources outside of the financial institution server, for example online maps or directories that provide location information for businesses and organizations. In this way, the location of the user may be known to the system, such that an offer may be presented to the user.

In some embodiments, the server determines the location of the point-of-transaction device from the user's position. In an embodiment, positioning data of the customer may include mobile device data. Mobile device data may include information regarding the location of the customer's mobile device. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. For instance, the location of the mobile phone may be dynamically determined from the cell phone signal and cell towers being accessed by the mobile phone. In other instances, a mobile device may include software or hardware to locate the position of the mobile phone from GPS signals, wireless network locations, and the like. In some embodiments, mobile device data may be the time and location of calls placed using the telephone functionality of a mobile device. In yet other embodiments, the mobile device data may be data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (from a compass in the mobile device). Such information may be sufficient to locate the user's position and hence the location of the point-of-transaction device.

In some embodiments, the positioning data of the user may also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks as well as any one or more existing web logs or “blogs,” forums and other social spaces. Social network data may indicate the customer's recent, present or future location through expressed data. For instance, a user may upload a blog post, comment on a connection's page, send a friend an electronic message etc. that she is traveling to a specific location or that she is currently in a specific city, or on a specific road etc. Moreover, many already-existing social networks provide users with the ability to “check-in,” “flag” or otherwise indicate the user's current location. Accordingly, user positioning data collected from social networking data may consist of such indications. Furthermore, many social networks allow users to rate, like, comment etc. on restaurants, attractions, locations and the like. Accordingly, a user may indicate that she ate at a certain restaurant or business at a given time and thereby provide information about her location at that time. Furthermore, a customer may upload photographs to a social networking site and thereby provide information about the user's location. In some instances the user's location may be determined from the picture, (for example a picture of a state line sign, a highway sign, a mile marker etc.) or a caption associated with the picture may indicate the customer's location and/or the time the photo was taken. In this manner, the location of the point-of-transaction device can be inferred from the location of the user when conducting the transaction.

In still further embodiments, the positioning data of the user may also be collected from Internet data. Internet data may include any information relating to the searches conducted by the customer, website's visited by the customer and the like that suggests the user's present or future location(s). For instance, in preparing for a vacation a user may conduct searches for hotels, restaurants or activities in the area where the user will be staying. Similarly, a user may review weather forecasts for locations other than her place of residence indicating that she may soon be traveling to that location. A user may also search for construction or traffic reports indicating future travel along certain roads. Moreover, changes in search patterns may suggest a customer's future location. For instance if a user usually uses a web browser application just to read online news articles or to check sports scores but suddenly begins to search for camping gear, hiking manuals and boots it may be indicative that the customer is anticipating taking a hiking trip and will be traveling away from her home area. It will be understood that such Internet data may relate to searches or websites visited by the user before she began traveling, however, inasmuch as many mobile devices also include mobile Internet connectivity, it will also be understood that such information may be dynamically collected as the user travels. Using the information related to the user's Internet activity, the location of the user can be determined and the location of the point-of-transaction device can thus be inferred. In some embodiments, the location of the user along with other factors may allow the system to predict the business the user is purchasing from as well as where the user may be going.

In some embodiments, the financial institution allows businesses or organizations to provide or update their own location information. For example, the financial institution may provide a service to businesses where businesses are allowed to provide offers to users by paying an assessment, such as a flat assessment or an assessment per offer provided. In another embodiment, the server determines the location of the point-of-transaction device by evaluating information relating to the user. For example, the server may receive GPS location from the user's mobile device at the time of the transaction. This information may be solicited by the server over the network or the information may automatically be provided, such as in a mobile payment application on a mobile device.

In decision block 516, it is determined whether there is an offer in the proximity of the point-of-transaction device. In an embodiment, the proximity database determines whether there is an offer in the proximity of the point-of-transaction device. The server provides the location of the point-of-transaction device and then evaluates whether any offers currently available in the proximity database are in the proximity of the point-of-transaction device. Proximity may be defined by the financial institution, by the user, or by the business or organization providing the offer. For example, the financial institution may determine that any offer within five miles of the user's current location is within the proximity of the user. The user may determine that any offer within the same locale, e.g., the same shopping mall, is in the proximity of the user. Further, the business providing the offer may request that any users within ten minutes travel time of the business be considered for receiving the offer. Any or all of these definitions for proximity may be used by the computer-implemented method to determine whether an offer is in the proximity of the user.

If there is no offer within the predetermined distance, the computer-implemented method ends the process and the user does not receive an offer, as depicted in block 518. The computer-implemented method can continue to monitor the user's transactions and repeat the process when the user conducts another transaction at a point-of-transaction device.

If, however, there is at least one offer within in the proximity of the point-of-transaction device, a second decision block is reached. In block 520, it is determined whether there is more than one offer in proximity to the point-of-transaction device. If there is more than one offer available to be presented to the user, the computer-implemented method goes through a process of determining which offer from among the plurality of offers will be presented to the user, as will be discussed in blocks 522 and 524. If there is only one offer available in proximity to the point-of-transaction device, then that offer is provided to the user, as will be discussed in block 526.

In block 522, the computer-implemented method determines which offer from a plurality of offers is provided to the user. Different variables may be used to determine which offer from a plurality of offers is provided to the user. For example, absolute distance (i.e., as the crow flies), distance based on various modes of travel (e.g., driving, walking, trains, etc.), proximity based on travel time, or other variables directly related to the travel between the current point-of-transaction device and the business or organization associated with the offer.

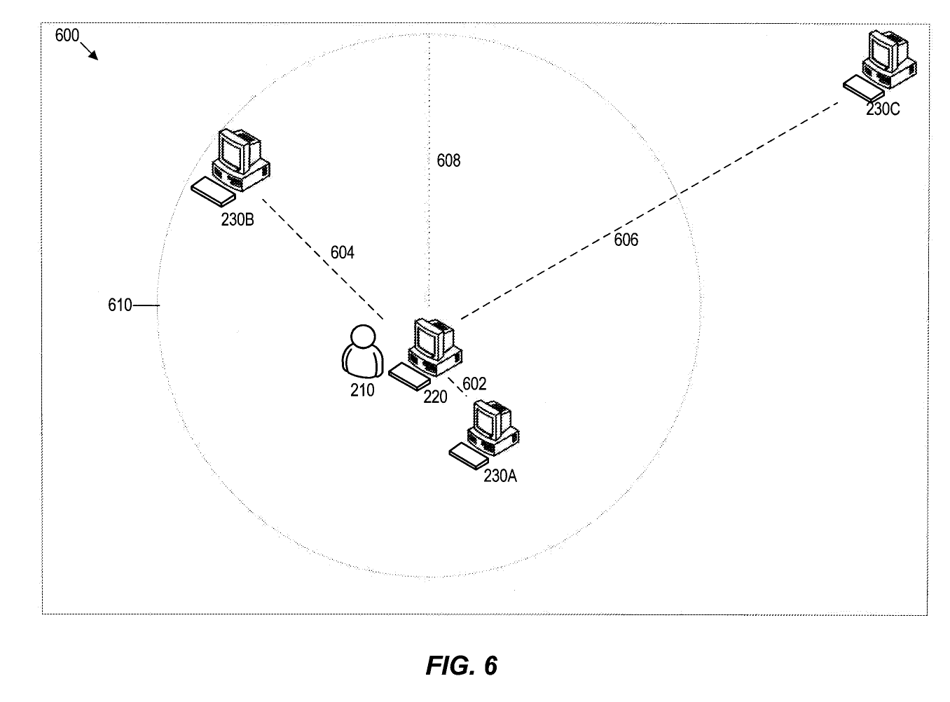

Absolute distance is the straight line distance between the current point-of-transaction device and the offers. In an embodiment, the direct-line distance may be modified, such as by the log of the distance or by squaring the absolute distance to derive a modified distance. Absolute distance may be used as a simple proxy for travel time and may also be used when routing information such as road maps or walking paths in shopping malls is not available. FIG. 6 depicts a model where absolute distance is used in part to select an offer from a plurality of offers.

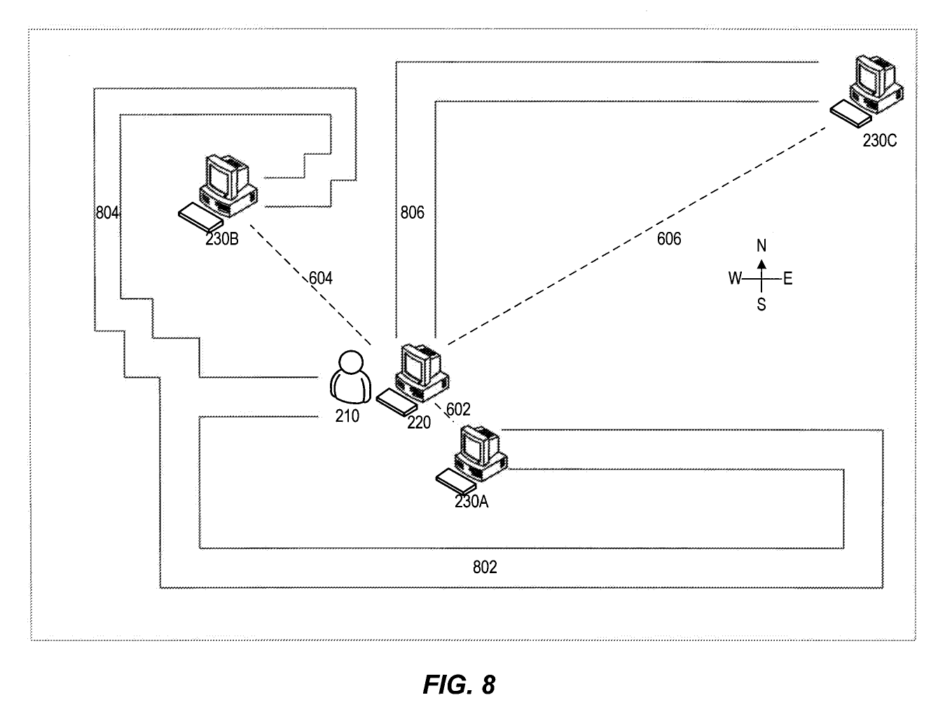

Distance based on various modes of travel is a revised version of geographic distance that models the travel distance based on the likely or the shortest travel path. Commuting patterns may be analyzed for the user, for the general population, or for other populations (e.g., the user's connections on a social networking site). For example, the proximity database may include maps of roads between the user and the various offers in the user's vicinity. The server then determines the distance traveled by the user to reach each of the offers. FIG. 8 depicts a model where travel distance is used in part to select an offer from a plurality of offers. In an embodiment, the offer with the shortest travel distance based on the mode of transportation is selected. It should be understood that modes of transportation other than driving automobiles may be considered. For example, bike routes may be provided and may include both roads and bike paths. Subway or train routes may also be considered.

Determining the estimated travel time for the user to reach the various offers is another means to select an offer from a plurality of offers. The travel time may be estimated based on the mode of travel and issues with the routes. For example, Offer A may be within a shorter driving distance than Offer B but congestion on the road to Offer A may make it faster to drive to Offer B. Road construction may be evaluated, traffic jams may be reviewed, and rush hour may be avoided by selecting an appropriate offer that avoids these issues from the plurality of offers. Different modes of travel may also be compared. For example, an offer may be considered too far away based on travel time when traveling by subway but may be easily reached by car.

The characteristics of the transaction or characteristics of the user may also be used to determine which offer from a plurality of offers to provide to the user. In an embodiment, the amount of the transaction may be used to determine which offer from a plurality of offers will be provided to the user. The time of the transaction may also influence which offer will be provided to the user. For example, if a user conducts a transaction around a mealtime the computer-implemented method may be more likely to send the user an offer related to restaurants in the proximity of the user. The category of the transaction may also influence which offer is provided to the user. For example, if the user is shopping at a baby clothing store an offer related to baby food at a nearby grocery store may be provided to the user instead of offers that are not related to the categories of the transaction. The category of the transaction may be known based on the business at which the transaction is completed or may be indicated in the data received from the point-of-transaction device.

In an embodiment, the characteristics of the user may also influence which offer from a plurality of offers is provided to the user. The account balances of the user, the status (e.g., preferred customer, gold card member, rewards member, etc.), the residence or mailing address, or other characteristics of the user may be used to determine which offer is provided. In an embodiment, the transaction history of the user is also considered when determining which offer from a plurality of proximate offers is provided to the user. If a user has previously conducted a transaction at a business, the user may receive offers from the business preferentially over other offers also located proximate to the user. In some embodiments, offers may be targeted to individuals residing within a region to increase the chance of return business. For example, a user may be conducting a transaction at a store while on a vacation in a state that is not the user's home state. The user may be more likely to receive offers related to restaurants than to home improvement stores because the user is less likely to purchase home improvement goods while away from home. The residence of the user stored with the financial institution may be used to determine whether the user is conducting a transaction near the user's residence.

In further embodiments, the user's previous acceptance of offers is used to determine whether a new offer should be provided to the user. The computer-implemented method is able to determine whether after receiving an offer for a business, the user goes to that business and conducts a transaction. In this manner, the user response to offers can be used to provide more effective targeting of offers. For example, if a user goes to a donut shop every time after receiving an offer for a donut shop based on the user's transaction history, the user may be predisposed to receive offers to donut shops when more than one offer is available in proximity to the user. In further embodiments, the likelihood that a user will be interested in an offer, i.e., conduct a transaction at a business associated with the offer, influences the determination of proximity. In the donut shop example, an offer to a donut shop may be considered in proximity to the user when the user is twenty miles away from the offer when all other types of offers are only considered in proximity to the user when the user is ten miles away from the offer. Whether a user is likely to accept an offer or likely to not accept an offer can both be used to more accurately target offers to individuals that might be interested in the goods and services being provided.

In some embodiments, the user's social network is used to determine which offers in proximity to the user will be presented to the user. In one embodiment, the user's connections on social networking sites are identified and used to select an offer from a plurality of offers. For example, if five offers from stores within a shopping mall are available, the computer-implemented method may identify the user's connections on a social networking site, determine which of the five stores the connections shop at most frequently or most recently, and provide an offer from that store to the user. In another embodiment, the offers are also provided to members of the user's social network. For example, if a user is conducting a transaction at a store and an offer is determined for that user at a nearby store, the user's connections on a social networking site may also be presented with the offer. In a still further embodiment, the user's connections are presented the offer and all of the recipients are informed that their connection or connections have also been made the offer. In this manner, the computer-implemented method encourages social activity around shopping while still maintaining convenience for the original user. It is also understood that the user could opt to forward offers he/she receives to third parties via email, text, SMS, sharing on social media, etc.

In an embodiment, the businesses associated with offers also influence which offer a user will receive from a plurality of offers. For example, businesses may pay an assessment to have their offer provided to users that previously conducted a transaction over a specific amount, such as $100. An individual that conducts a transaction for more than $100 may be an individual that some businesses want to target with offers when those individuals are in the vicinity of the user. Businesses may also want to target users that have conducted transactions at their business previously or that have conducted transactions at their competitors. This type of information may be available in the user's transaction history with the financial institution.

It should be understood that these means for determining an offer from a plurality of offers may be combined in a variety of ways. For example, travel distance and customer transaction history may both be considered when evaluating a plurality of offers. The computer-implemented method may set a maximum travel distance that defines a first set of offers. The computer-implemented method may then determine which of the businesses associated with the offers the user has conducted the most previous transactions according to the user's transaction history. In this manner, both travel distance and user characteristics are used to determine which offer from a plurality of offers will be provided to the user. Similarly, other methods of determining offers may be combined to determine which offer to provide to a user. For example, offers may be evaluated based on the number of turns it would require to reach the offer when driving, based on the theory that the greater the number of turns the more likely it is that the user will make a wrong turn.

In block 524, the computer-implemented method customizes the offer for the user. In one embodiment, the computer-implemented method supplements the offer with user-specific data. For example, the computer-implemented method may supplement the offer with the user rewards number or membership card. If a user receives an offer to shop at a grocery store, the user may receive a MMS text message that includes a scannable image of the user's rewards card for the grocery store. Then, even if the user does not have the rewards card with them, the user is able to go to the grocery store, make a purchase, and use the rewards card to purchase the item. In another embodiment, the offer is customized by presenting information to the user regarding the offer. For example, if the offer is for a sale at a nearby business the computer-implemented method may supplement the offer with the total amount of money spent at the business by the user, the total number of transactions conducted at the business by the user, or other information.

In block 526, the server provides the offer to the user. As discussed, the server may provide the offer to the user in a variety of ways. In an embodiment, the server provides the offer to the user by contacting the user through the user's mobile device. For example, the user may receive a text message (e.g., a short message service, SMS, or a multimedia messaging service, MMS, etc.) on the user's mobile device alerting them to the offer. In another embodiment, the server provides a pre-recorded, automated, or live phone call to the user providing the offer. In a still further embodiment, the server provides an email, a contact via a social networking site, or other contact means to provide the offer to the user. In some embodiments, the current point-of-transaction is configured or prompted to provide the offer to the user. For example, the offer may be printed on the receipt received at the first point-of-transaction device. Take the example where the user receives a limited-time coupon to use at a nearby store. The coupon may be printed on the receipt received at the first location and provide an offer for a sale at a nearby business.

In an embodiment, the offers are time limited to provide an incentive to the user to visit the business. For example, the offer may provide a coupon worth a certain percent off of a purchase at a nearby business if the purchase is made within the next hour. The offer also informs the user that the business is located within a ten minute drive of the user's location, and in some embodiments may offer to provide directions to the business. In this manner, the computer-implemented method makes shopping easy and convenient while providing businesses with targeted, effective marketing strategies.

In block 528, the user receives the offer from the server. In an embodiment, the user receives a notification on the user's mobile device that a text message, email, or social networking message has been received. In another embodiment, the user's mobile phone informs the user that the user is receiving a phone call. In a still further embodiment, the point-of-transaction device provides a receipt or notice providing the offer. The offer may be verbal or written. In an embodiment, the offer is a pre-recorded voice. In another embodiment, the offer is a written solicitation.

In block 530, the user requests assistance regarding the offer. For example, the user may request directions to the business associated with the offer. In an embodiment, this service is provided for an assessment. The user may by default agree to pay the assessment, may pay in advance for the service, such as per assistance or for a flat assessment, or may agree to pay the assessment at the time of the offer. For example, the user may agree to pay the assessment at the time of the offer and then pay the assessment at the current point-of-transaction device.

Turning now to block 532, the server provides assistance to the user. In an embodiment, the server provides directions to the user. For example, the server may send the user an email with turn by turn directions, such as in a web-based mapping application. In another example, the server tracks the user's movement based on a positioning device, such as a GPS device, in the user's mobile device and sends the user text messages with instructions in how to reach the business associated with the offer. The text messages may be generated and sent as the user needs and can be adjusted if the user takes a wrong turn or makes a detour. In a still further embodiment, the user may receive a phone call from a recorded or live person providing assistance with respect to the offer. For example, the user may be able to pay an assessment and receive an immediate phone call from a person, wherein the person is prepared to stay on the line and provide directions to the user until the user reaches the business. In an embodiment, the person providing the assistance is a third party contractor. In another embodiment, the person providing the assistance is affiliated with the business providing the offer.

In block 534, the server determines that the user is initiating a transaction at the second point-of-transaction device. The user may have been motivated to visit the second point-of-transaction device by the first offer or the user may have visited the second point-of-transaction device independently. The computer-implemented method may store the user's actions in the proximity database so that future offers may be more accurately tailored to the user's preferences. In block 534, the computer-implemented method is able to begin the process again by receiving financial account information, determining an offer based on proximity to the point-of-transaction device, and providing the offer to the user.

Turning now to FIG. 6, a schematic diagram 600 of a user in an environment is provided, wherein a plurality of offers are located proximate to the user. In an embodiment, the user 210 is conducting a transaction at the point-of-transaction device 220. The computer-implemented method determines that the user 210 initiated a transaction at the point-of-transaction device 220 and determines both the user's identity and the location of the point-of-transaction device 220. The computer-implemented method then determines whether offers are located in the proximity of the point-of-transaction device. In this example, three offers associated with three additional point-of-transaction devices 230A, 230B, and 230C are located in proximity to the user 210. In an embodiment, the proximity database in conjunction with the server determines a distance 602 between the user 210 and first point-of-transaction device 230A, determines a second distance 604 between the user 210 and the second point-of-transaction device 230B, and determines a third distance 606 between the user 210 and the third point-of-transaction device 230C. These distances, alone or in conjunction with user characteristics, transaction characteristics, or offer characteristics determined by the offer provider, can be used to select which of the offers are provided to the user. For example, the computer-implemented method may determine that only offers with a predetermined radius 608 of the user may be considered for the offer. This radius 608 defines a region including only offers 230A and 230B. Within the region, the computer-implemented method may determine that the offer at which the user has conducted the most previous transactions within the previous year will be selected. The computer-implemented method analyzes the user's transaction history and determines that the user conducted three transactions at 230A (i.e. the nearest offer based on distance 602) and that the user conducted eight transactions at 230B (i.e. the farther offer within the region defined by radius 608). Thus, the computer-implemented method determines that the offer associated with 230B will be provided to the user.

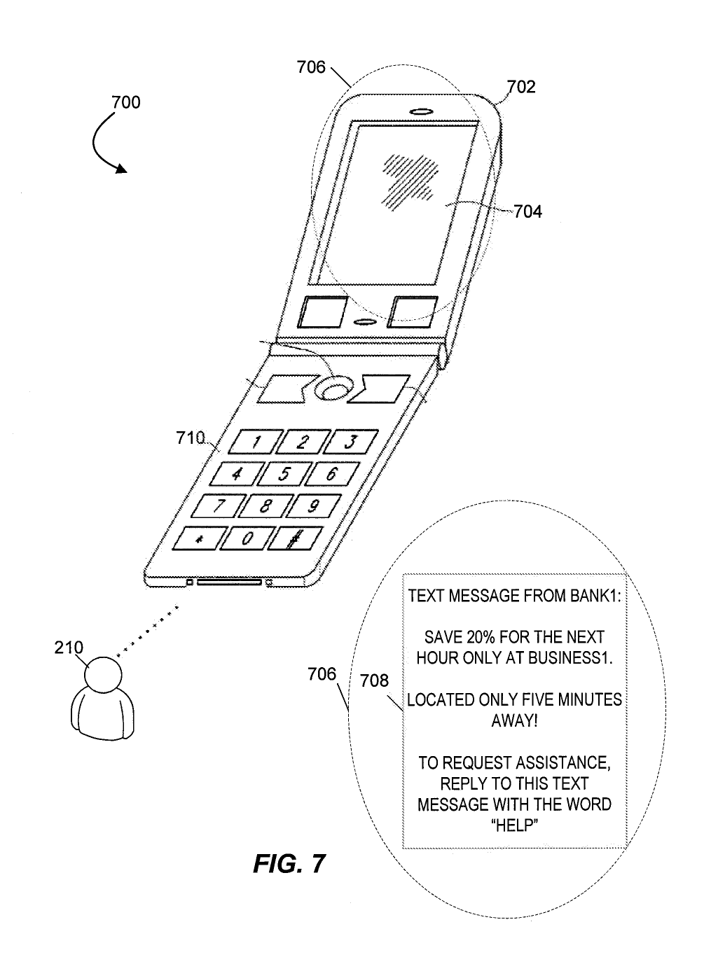

In FIG. 7, an example 700 of a method of providing the offer to the user is presented, in accordance with an embodiment of the invention. In this example, the user 210 receives a text message 708 on the user's mobile device 702. The text message is displayed on the screen 704 in response to the user conducting a transaction at a point-of-transaction device. Advantageously, the message is able to immediately provide an offer to a user in a shopping mode, indicate that the business associated with the offer is very close, and offer assistance to the user. In an embodiment, the user responds to the offer using an input device 710, such as a keypad or touch-sensitive screen.

In FIG. 8, a schematic diagram 800 of a user in an environment is provided, wherein the user receives directions to the offer in response to the user request. Similar to FIG. 6, the user 210 is conducting a transaction at a point-of-transaction device 220. The computer-implemented method determines that the user 210 initiates the transaction and determines the identity of the user 210 and the location of the point-of-transaction device 220. The proximity database 300 in coordination with the server determines the distance between the user 210 at the point-of-transaction device 220 and offers 230A, 230B, and 230C. Again, 230A is the closest based on straight-line distance 602 but in this embodiment, the computer-implemented method determines which offer to provide based on shortest driving distance. Under this standard, 230C is the closest to the user because distance 806 is shorter than distance 804 and distance 802. In another embodiment, the computer-implemented method determines which offer to provide based on least number of turns. Again, offer 230C would be provided to the user because there is only a single turn on the route from 220 to 230C rather than ten turns to reach 230B and four turns to reach 230A.

If the user 210 in FIG. 8 is receiving assistance from the computer-implemented method, the user may receive an email or text message after completing the transaction at 220. The email or text message may provide directions to the user from the user's current location to the business associated with offer 230C. In another embodiment, the computer-implemented method sends the address to the user's mobile device and activates a mapping application on the user's mobile device to provide the user turn-by-turn directions. In this manner, the user is able to determine the directions in association with a positioning system, such as a GPS or tower triangulation device, associated with the user's mobile device. The computer-implemented method may be able to determine the user's location based on communication between the user's mobile device and the proximity database over the network. It should be understood that while the directions are referenced with regard to cardinal directions, the directions can be provided in any manner, for example by instructing the user 210 to turn right or left, go straight, using street names, etc.

The above description refers to a centralized server as the computing device processor and describes the server as performing the computer-implemented method. It should be understood, however, that the computing device processor can be a mobile device of the user and the processor associated with the mobile device can perform the computer-implemented method. In one embodiment, the data processing associated with the computer-implemented method can be performed on the mobile device and the data can be stored on remote servers. For example, the mobile device may communicate with the remote servers to receive data associated with the user's transaction history and offers and then perform the computer-implemented method based on the data received from the remote servers. In another embodiment, the data is stored on the mobile device. For example, the user's transaction history and offers may be intermittently or regularly uploaded to a secure database on the user's mobile device and accessed when the computer-implemented method is activated on the user's mobile device. In this example, the computer-implemented method is capable of operating when the user does not have access to wireless networks, such as in areas of low coverage or where buildings prevent coverage.

The flowcharts and block diagrams in the figures illustrate the architecture, functionality, and operation of possible implementations of apparatuses, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, functions repeated by the two blocks shown in succession may, in fact, be executed substantially concurrently, or the functions noted in the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer-executable instructions.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Embodiments of the present invention are described below with reference to flowchart illustrations and/or block diagrams of such methods and apparatuses. It will be understood that blocks of the flowchart illustrations and/or block diagrams, and/or combinations of blocks in the flowchart illustrations and/or block diagrams, can be implemented by computer-executable program instructions (i.e., computer-executable program code). These computer-executable program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block or blocks. As used herein, a processor may be “configured to” perform a certain function in a variety of ways, including, for example, by having one or more general-purpose circuits perform the function by executing one or more computer-executable program instructions embodied in a computer-readable medium, and/or by having one or more application-specific circuits perform the function.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. In the context of this document, a computer-readable storage medium may be any medium that can contain or store data, such as a program for use by or in connection with an instruction execution system, apparatus, or device. The computer-readable medium may be a transitory computer-readable medium or a non-transitory computer-readable medium.

A transitory computer-readable medium may be, for example, but not limited to, a propagation signal capable of carrying or otherwise communicating data, such as computer-executable program instructions. For example, a transitory computer-readable medium may include a propagated data signal with computer-executable program instructions embodied therein, for example, in base band or as part of a carrier wave. Such a propagated signal may take any of a variety of forms, including, but not limited to, electro-magnetic, optical, or any suitable combination thereof. A transitory computer-readable medium may be any computer-readable medium that can contain, store, communicate, propagate, or transport program code for use by or in connection with an instruction execution system, apparatus, or device. Program code embodied in a transitory computer-readable medium may be transmitted using any appropriate medium, including but not limited to wireless, wired, optical fiber cable, radio frequency (RF), etc.

A non-transitory computer-readable medium may be, for example, but not limited to, a tangible electronic, magnetic, optical, electromagnetic, infrared, or semiconductor storage system, apparatus, device, or any suitable combination of the foregoing. More specific examples (a non-exhaustive list) of the non-transitory computer-readable medium would include, but is not limited to, the following: an electrical device having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It will also be understood that one or more computer-executable program instructions for carrying out operations of the present invention may include object-oriented, scripted, and/or unscripted programming languages, such as, for example, Java, Perl, Smalltalk, C++, SAS, SQL, Python, Objective C, and/or the like. In some embodiments of the invention, the one or more computer-executable program instructions for carrying out operations of embodiments of the present invention are written in conventional procedural programming languages, such as the “C” programming languages and/or similar programming languages. The computer program instructions may alternatively or additionally be written in one or more multi-paradigm programming languages, such as, for example, F#.

The computer-executable program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention may take the form of an entirely hardware embodiment of the invention, an entirely software embodiment (including firmware, resident software, micro-code, etc.), or an embodiment combining software and hardware aspects that may generally be referred to herein as a “module,” “application,” or “system.”

It should be understood that terms like “bank,” “financial institution,” and “institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire invention on their own computer systems or even a single work station if appropriate databases are present and can be accessed.

The terminology used herein is for the purpose of describing particular embodiments only and is not intended to be limiting of the invention unless the context clearly indicates otherwise. As used herein, the singular forms “a,” “an,” and “the” are intended to include the plural forms as well, unless the context clearly indicates otherwise. It will be further understood that the terms “includes,” “has,” “comprises,” “including,” having,” and/or “comprising,” when used in this specification, specify the presence of stated features, integers, steps, operations, elements, and/or components in the stated embodiment of the invention, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A computer-implemented method of providing an offer based on proximity to a point-of-transaction device, the method comprising:
receiving data associated with a transaction at a point-of-transaction device, wherein the data includes financial account information;
identifying, via a computing device processor, a user associated with the financial account information;
determining, via a computing device processor, a location of the point-of-transaction device; and
providing an offer to the user based at least in part on the location of the point-of-transaction device.

2. The computer-implemented method of claim 1, further comprising selecting, via a computing device processor, the offer from a plurality of offers based on proximity to the point-of-transaction device.

3. The computer-implemented method of claim 2, wherein the proximity to the point-of-transaction device is based on a path analysis in an automobile.

4. The computer-implemented method of claim 2, wherein the proximity to the point-of-transaction device is based on a travel time analysis.

5. The computer-implemented method of claim 1, further comprising customizing, via a computing device processor, the offer for the user based on at least one previous financial transaction of the user.

6. The computer-implemented method of claim 5, wherein customizing the offer further comprises analyzing, via a computing device processor, the at least one previous financial transaction of the user, and determining the offer to provide to the user based on the at least one financial transaction.

7. The computer-implemented method of claim 1, wherein receiving data associated with the transaction at the point-of-transaction device further comprises receiving payor account data and payee account data.

8. The computer-implemented method of claim 1, wherein identifying the user associated with the financial account information further comprises identifying, via a computing device processor, a financial account associated with the financial account information and determining, via a computing device processor, the user associated with the financial account.

9. The computer-implemented method of claim 8, further comprising determining, via a computing device processor, contact information for the user, wherein the contact information is selected from the group consisting of a telephone number, an email address, and a social networking ID.

10. The computer-implemented method of claim 1, wherein determining the location of the point-of-transaction device comprises determining at least one of geographic coordinates of the point-of-transaction device, a street address of the point-of-transaction device, and a locality of the point-of transaction device.

11. The computer-implemented method of claim 1, wherein providing the offer to the user further comprises sending the offer to the user by a contact channel, wherein the contact channel is selected from the group consisting of a telephone number, an email address, and a social networking ID.

12. The computer-implemented method of claim 1, further comprising providing, via a computing device processor, directions to a business associated with the offer.

13. The computer-implemented method of claim 1, further comprising providing, via a computing device processor, an address to a business associated with the offer.

14. A system for providing an offer based on proximity to a point-of-transaction device, the system comprising:
a computing platform including a processor and a memory;
an identification routine stored in the memory, executable by the processor and configured to identify a user and a location of at least one point-of-transaction device associated with an offer, wherein the point-of-transaction device is in proximity to the user;
a proximity database stored in the memory and configured to provide data associated with the location of the point-of-transaction device;
an offer selection routine stored in the memory, executable by the processor and configured to determine an offer to provide to the user based on proximity to the point-of-transaction device; and
an offer providing routine stored in the memory, executable by the processor and configured to provide the offer to the user.

15. The system of claim 14, wherein the data provided by the proximity database includes a point-of-transaction device in proximity to the user.

16. The system of claim 15, wherein the point-of-transaction device is in proximity to the user when the point-of-transaction device is the nearest point-of-transaction device associated with an offer to the user.

17. The system of claim 15, wherein the point-of-transaction device is in proximity to the user when the point-of-transaction device would take the least amount of time to reach for the user.

18. The system of claim 14, further comprising a direction providing routine stored in the memory, executable by the processor and configured to provide directions in how to get to the point-of-transaction device associated with the offer to the user.

19. The system of claim 18, wherein the direction providing routine provides turn by turn directions to the user.

20. The system of claim 14, further comprising an offer customization routine stored in the memory, executable by the processor and configured to customize the offer for the user based at least in part on financial history of the user.

21. The system of claim 20, wherein the offer is customized by preferentially providing offers to businesses which the user is known to have patronized.

22. The system of claim 20, wherein the offer is customized by modifying the offers based on a characteristic of the transaction, wherein the characteristic is at least one of an account balance of the user, a residence of the user, a time of the transaction, a category for the point-of-transaction device, an amount of the transaction, and a frequency of the transaction.

23. A computer program product for providing an offer based on proximity to a point-of-transaction device, the computer program product comprising:
a computer-readable medium comprising:
a first set of codes for causing a computer to receive data associated with a transaction at a point-of-transaction device, wherein the data comprises financial account information;
a second set of codes for causing a computer to identify a user conducting the transaction from the financial account information;
a third set of codes for causing a computer to determine a location of the point-of-transaction device;
a fourth set of codes for causing a computer to determine an offer in proximity to the point-of-transaction device; and
a fifth set of codes for causing a computer to provide the offer to the user.

24. The computer program product of claim 23, wherein the data include financial account information for the user.

25. The computer program product of claim 23, further comprising a sixth set of codes for causing a computer to customize the offer for the user.

26. The computer program product of claim 25, wherein the offer is a coupon for a business, and wherein the value of the coupon is dependent upon the amount of the transaction.

27. The computer program product of claim 25, wherein the offer is customized based on the category of the transaction.

28. The computer program product of claim 25, wherein the offer is customized based on the time of the transaction.

29. The computer program product of claim 23, wherein the offer is provided to the user by at least one of a text message, a phone call, an email, and a social networking contact.

30. The computer program product of claim 23, further comprising a seventh set of codes for causing a computer to provide directions to a business associated with the offer.

31. The computer program product of claim 30, wherein the directions are provided to the user in an email.

32. The computer program product of claim 23, further comprising evaluating a second transaction at a second point-of-transaction device and providing a second offer to the user based on the first transaction and the second transaction.

33. The computer program product of claim 23, further comprising:
an eighth set of codes for causing a computer to associate the data with a financial account of a user; and
a ninth set of codes for causing a computer to identify contact information for the user associated with the financial account.

34. The computer program product of claim 23, wherein the computer-readable medium is stored on a mobile device of the user.

35. The computer program product of claim 23, wherein the offer is selected from a plurality of offers based at least in part on a social network of the user.

36. The computer program product of claim 23, wherein the offer is selected from a plurality of offers based at least in part on acceptance of related offers by the user.
